(19) United States
(12) Patent Application Publication
(10) Pub. No.: US 2025/0335251 A1
(43) Pub. Date: Oct. 30, 2025

(54) COMPUTER-READABLE RECORDING MEDIUM STORING SCHEDULING PROGRAM, INFORMATION PROCESSING APPARATUS, AND SCHEDULING METHOD

(71) Applicant: Fujitsu Limited, Kawasaki-shi (JP)

(72) Inventors: Godai TAKASHINA, Matsudo (JP); Yoshifumi UJIBASHI, Kawasaki (JP)

(73) Assignee: Fujitsu Limited, Kawasaki-shi (JP)

(21) Appl. No.: 19/068,352

(22) Filed: Mar. 3, 2025

(30) Foreign Application Priority Data
Apr. 26, 2024 (JP) 2024-072698

(51) Int. Cl. G06F 9/50

(52) U.S. Cl. CPC G06F 9/5027

(57) ABSTRACT

A recording medium stores a program for causing a computer that includes a first computing resource and a second computing resource that has a processing performance lower than a processing performance of the first computing resource to execute a process including: activating a process; and managing a mapping state of the first computing resource. In the activating, execution of the process is registered as a target of the management of the mapping state of the first computing resource, it is determined whether there is the first computing resource mappable to the process when a notification that requests mapping of the first computing resource is output from the process, the process is mapped to the first computing resource in a case where there is the mappable first computing resource, and the process is mapped to the second computing resource in a case where there is not the mappable first computing resource.

### CROSS-REFERENCE TO RELATED APPLICATION

This application is based upon and claims the benefit of priority of the prior Japanese Patent Application No. 2024-72698, filed on Apr. 26, 2024, the entire contents of which are incorporated herein by reference.

### FIELD

The embodiment discussed herein is related to a computer-readable recording medium storing a scheduling program, an information processing apparatus, and a scheduling method.

### BACKGROUND

It is known that processing performance is improved by using a graphics processing unit (GPU) instead of a central processing unit (CPU) for execution of a deep learning application (hereinafter, referred to as a deep learning app).

Japanese National Publication of International Patent Application No. 2022-515302, International Publication Pamphlet No. 2022/269870, and Japanese Laid-open Patent Publication No. 2019-57303 are disclosed as related art.

### SUMMARY

According to an aspect of the embodiments, a non-transitory computer-readable recording medium stores a scheduling program for causing a computer that includes a first computing resource and a second computing resource that has a processing performance lower than a processing performance of the first computing resource to execute a process including: activating a process; and managing a mapping state of the first computing resource. In the activating, execution of the process is registered as a target of the management of the mapping state of the first computing resource, it is determined whether or not there is the first computing resource mappable to the process when a notification that requests mapping of the first computing resource is output from the process, the process is mapped to the first computing resource in a case where there is the mappable first computing resource, and the process is mapped to the second computing resource in a case where there is not the mappable first computing resource.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is a diagram schematically illustrating a configuration of a scheduling system according to an embodiment;

FIG. 2 is a block diagram illustrating a hardware (HW) configuration example of a computer that realizes functions of the scheduling system according to the embodiment;

FIG. 3 is a diagram for describing GPU mapping by a scheduler in the scheduling system according to the embodiment;

FIG. 4 is a diagram for describing GPU mapping based on priority by the scheduler in the scheduling system according to the embodiment;

FIG. 5 is a diagram for describing processing at the time of execution of a user program in the scheduling system according to the embodiment;

FIG. 6 is a sequence diagram for describing a flow of processing in a driver program, a user process, and a scheduler of the scheduling system according to the embodiment; and

FIG. 7 is a diagram for describing dynamic mapping of computing resources in the scheduling system according to the embodiment.

### DESCRIPTION OF EMBODIMENTS

Since unit price of the GPU is higher than unit price of the CPU, it is important to efficiently share and use a small number of GPUs among a plurality of processes.

In a known job scheduler such as Slurm, since the GPUs continue to be occupied from the start to the end of process execution, jobs exceeding the number of GPUs are unable to be executed simultaneously. A job for which a GPU may not be secured is put into a job queue, and waits until a process which is using the GPU is completely ended.

GPU preemption is known as a method of efficiently using the GPU. In the GPU preemption, it is possible to stop the job which is using the GPU from outside, and it is possible to transfer a right to use the GPU to another job. Such GPU preemption is periodically performed, and thus, the process which using the GPU may be switched on a time basis. As a result, a subsequent job may use the GPU without waiting until the preceding job completely stops.

However, in the GPU preemption, the GPU continues to be occupied even though there is a period in which the GPU is not used during the execution of the process. To suppress such occupancy of the GPU, GPU mapping is to be switched in accordance with a change in a processing content of the deep learning app over time.

However, in the GPU preemption, it is difficult to determine whether the GPU is being used during the execution of the process. For example, to enable the application to notify the outside of a use timing of the GPU, a change such as rewriting a code of the application is to be made.

In one aspect, an object of the present disclosure is to make it possible to efficiently map a GPU to a process.

Hereinafter, embodiments of a scheduling program, an information processing apparatus, and a scheduling method will be described with reference to the drawings. However, embodiments to be described below are merely examples, and are not intended to exclude the application of various modification examples and techniques that are not explicitly described in the embodiments. For example, the present embodiments may be carried out with various modifications without departing from the gist of the present embodiments. Each of the drawings is not intended to include only the constituent elements illustrated in the drawing, and other functions and the like may be included.

### (A) Configuration

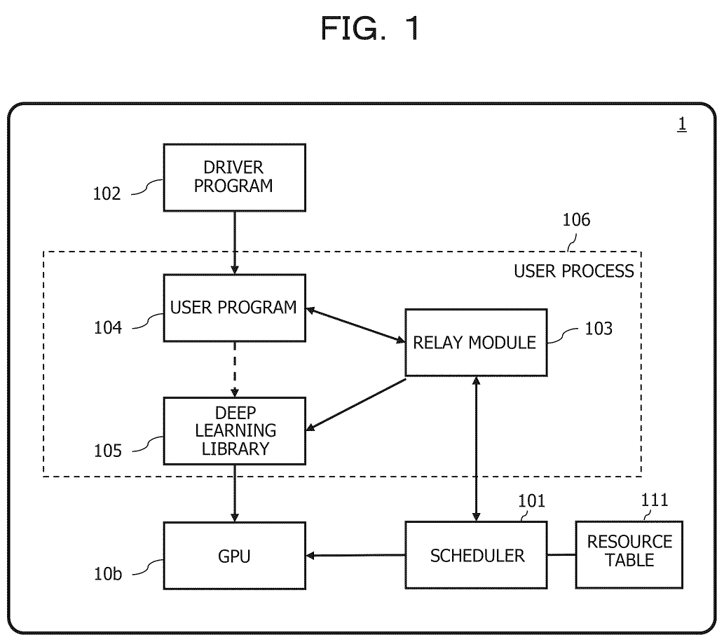

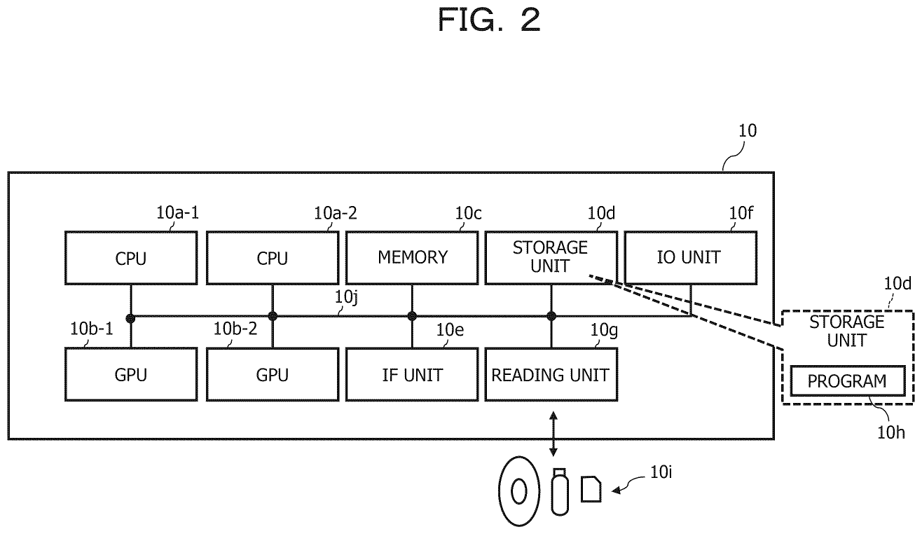

FIG. 1 is a diagram schematically illustrating a configuration of a scheduling system 1 according to an embodiment. FIG. 2 is a block diagram illustrating a hardware (HW) configuration example of a computer 10 that realizes functions of the scheduling system 1 according to the embodiment.

### (A-1) Hardware Configuration Example

In a case where a plurality of computers are used as HW resources that realize the functions of the scheduling system 1, each computer may include an HW configuration illustrated in FIG. 2.

As illustrated in FIG. 2, the computer 10 may be an information processing apparatus and may include, as the HW configuration, for example, one or more (two in the example illustrated in FIG. 2) CPUs 10a-1 and 10a-2, one or more (two in the example illustrated in FIG. 2) GPUs 10b-1 and 10b-2, a memory 10c, a storage unit 10d, an interface (IF) unit 10e, an input/output (IO) unit 10f, and a reading unit 10g. Hereinafter, in a case where the CPUs 10a-1 and 10a-2 are not distinguished from each other, these CPUs are each referred to as a CPU 10a. In a case where the GPUs 10b-1 and 10b-2 are not distinguished from each other, these GPUs are each referred to as a GPU 10b.

The CPU 10a is an example of an arithmetic processing device that performs various types of control and arithmetic operations, and is a control unit that executes various types of processing. The CPU 10a may be coupled to be able to communicate with each block in the computer 10 via a bus 10j. The bus 10j may be a peripheral component interconnect-express (PCIe) bus. The CPU 10a may be a multiprocessor including a plurality of processors, may be a multicore processor including a plurality of processor cores, or may have a configuration including a plurality of multicore processors.

For example, the GPU 10b may be an accelerator such as a general purpose computing on graphics processing unit (GPGPU). Screen display control may be performed on an output device such as a monitor in the IO unit 10f by using the GPU 10b. The GPU 10b may have a configuration as an accelerator that executes machine learning processing and inference processing using a machine learning model. As for the machine learning processing and the inference processing, it may be said that processing performance of the GPU 10b is higher than processing performance of the CPU 10a.

The CPUs 10a-1 and 10a-2 and the GPUs 10b-1 and 10b-2 are computing resources to be mapped to a user program 104 (described later). The GPUs 10b-1 and 10b-2 are each an example of a first computing resource, and the CPUs 10a-1 and 10a-2 are each an example of a second computing resource.

The GPU 10b-1 may be referred to as a GPU #1, and the GPU 10b-2 may be referred to as a GPU #2. The CPU 10a-1 may be referred to as a CPU #1, and the CPU 10a-2 may be referred to as a CPU #2.

The memory 10c is an example of HW that stores information such as various types of data and programs. Examples of the memory 10c include one or both of a volatile memory such as a dynamic random-access memory (DRAM) and a nonvolatile memory such as a persistent memory (PM).

The storage unit 10d is an example of HW that stores information such as various types of data and programs. Examples of the storage unit 10d include a magnetic disk device such as a hard disk drive (HDD), a semiconductor drive device such as a solid-state drive (SSD), and various storage devices such as a nonvolatile memory. Examples of the nonvolatile memory include a flash memory, a storage class memory (SCM), a read-only memory (ROM), and the like.

The storage unit 10d may store a program 10h (scheduling program) that realizes all or some of the various functions of the computer 10.

For example, the CPU 10a of the scheduling system 1 may realize a scheduling function (described later) by loading the program 10h stored in the storage unit 10d into the memory 10c and executing the program 10h.

The IF unit 10e is an example of a communication IF that performs control or the like of coupling and communication between the computer 10 and another computer. For example, the IF unit 10e may include an adapter that conforms to a local area network (LAN) such as Ethernet (registered trademark), optical communication such as fibre channel (FC), or the like. This adapter may support one or both of a wireless communication method and a wired communication method. The program 10h may be downloaded from a network to the computer 10 via this communication IF and may be stored in the storage unit 10d.

The IO unit 10f may include one or both of an input device and an output device. Examples of the input device include a keyboard, a mouse, a touch panel, and the like. Examples of the output device include a monitor, a projector, a printer, and the like. The IO unit 10f may include a touch panel or the like in which the input device and the output device are integrated. The output device may be coupled to the GPU 10b. The IO unit 10f may be an input device or an output device of another information processing apparatus remotely coupled to the computer 10 by a secure shell (SSH) or the like.

The reading unit 10g is an example of a reader that reads information of data and programs recorded in a recording medium 10i. The reading unit 10g may include a coupling terminal or device to which the recording medium 10i may be coupled or inserted. Examples of the reading unit 10g include an adapter that conforms to Universal Serial Bus (USB) or the like, a drive device that accesses a recording disk, a card reader that accesses a flash memory such as a secure digital (SD) card, and the like. The program 10h may be stored in the recording medium 10i, and the reading unit 10g may read the program 10h from the recording medium 10i and may store the program 10h in the storage unit 10d.

Examples of the recording medium 10i include a non-transitory computer-readable recording medium such as a magnetic/optical disc or a flash memory. Examples of the magnetic/optical disc include a flexible disc, a compact disc (CD), a Digital Versatile Disc (DVD), a Blu-ray disc, a Holographic Versatile Disc (HVD), and the like. Examples of the flash memory include a semiconductor memory such as a USB memory or an SD card.

The HW configuration of the computer 10 described above is an example. Accordingly, an increase or decrease (for example, addition or deletion of arbitrary block), division, or integration in arbitrary combination of the HW in the computer 10, or addition, deletion, or the like of a bus may be appropriately performed.

### (A-2) Functional Configuration Example

As illustrated in FIG. 1, the scheduling system 1 may include, for example, functions as a scheduler 101, a driver program 102, a relay module 103, the user program 104, and a deep learning library 105. These functions may be realized by the hardware of the computer 10 (see FIG. 2).

The user program 104, the deep learning library 105, and the relay module 103 may be referred to as a user process 106. The user process 106 is an example of a process.

The driver program 102 activates the user program 104 (described later), and causes the user program 104 to communicate with the relay module 103 (described later).

For example, the driver program 102 causes the user program 104 to communicate with the scheduler 101 (described later) via the relay module 103. The driver program 102 causes the user program 104 to load and execute the deep learning library 105 (described later).

The driver program 102 realizes these communications by the user program 104 without changing source codes of a deep learning program that realizes the user program 104.

Originally, the user program 104 performs access such as reading to the deep learning library 105. In the scheduling system 1, the driver program 102 causes the user program 104 to perform access such as reading to the deep learning library 105 via the relay module 103.

Originally, the user program 104 performs transmission of a GPU request, reception of a mapping notification, and the like with the scheduler 101. In the scheduling system 1, the driver program 102 causes the user program 104 to transmit and receive data and the like to and from the scheduler 101 via the relay module 103.

The driver program 102 performs replacement of a module to be read by the user program 104 by changing semantics (variables and the like) of module reading and by executing the user program 104.

Consequently, instead of performing an import access to the deep learning library 105, the user program 104 performs access such as import to the relay module 103. Instead of transmitting the GPU request to the scheduler 101, the user program 104 transmits the GPU request to the relay module 103.

For example, in the above-described replacement module, the driver program 102 may set a predetermined storage area which is accessible by the relay module 103 in the memory 10c or the storage unit 10d. For example, the driver program 102 may set a communication port or the like to be used for communication with the relay module 103 in the replacement module. The driver program 102 may generate a job identifier that is invariable by reactivation of the user program 104 and may inform the relay module 103 of the generated job identifier.

By allowing the user program 104 to use these storage areas, communication ports, and the like, the driver program 102 may cause the user program 104 to communicate with the relay module 103 with the intention of communicating with the deep learning library 105.

The semantics changed by the above-described driver program 102 may be different depending on an implementation language. For example, in the case of Python, the driver program 102 may change a behavior when the user program 104 executes an import statement by changing “sys.path” or “sys.meta_path” which is a variable incorporated in an interpreter.

In this manner, the driver program 102 replaces an access destination such that the reading performed by the user program 104 to the deep learning library 105 using the import statement is performed on the relay module 103 having an equivalent application programming interface (API). In this manner, the driver program 102 causes the user program 104 to transmit the GPU request or the like to the scheduler 101 via the relay module 103 having an equivalent API.

The driver program 102 replaces the reading destination of the deep learning library 105 by the user program 104 with the relay module 103. At an appropriate timing such as the start of learning iteration, the driver program 102 causes the user program 104 to automatically communicate with the scheduler 101 via the relay module 103.

It may be said that the driver program 102 registers execution of the user process 106 in the scheduler 101, as a target of management of a mapping state of the GPU 10b.

When specific processing such as a specific API call is performed in the user process 106 (the user program 104), the driver program 102 may cause a notification output to be performed.

When a computing resource (device) that executes the user program 104 is to be moved (changed), the driver program 102 temporarily stops the user program 104 and reactivates the user program 104 with a new computing resource.

The user program 104 is a program that realizes a process of performing training (deep learning) of a deep learning model (machine learning model) (not illustrated), and executes a job related to the deep learning. The user program 104 is, for example, a deep learning program.

The call of APIs for the deep learning library 105 is performed in learning processing of the deep learning model, and thus, the user program 104 calls the library provided by each API.

For example, while pre-processing and machine learning (hereinafter, may be simply referred to as learning) are repeatedly executed in deep learning, the user program 104 may call the API at each of the time of transition from the pre-processing to the learning and the time of transition from the end of the learning to pre-processing of next data, which is a post-process of the learning.

The user program 104 may call the API at each of the time of transition to predetermined specific processing with a relatively low load in which the GPU 10b is not used and conversely at the time of transition to predetermined specific processing with a relatively high load in which the use of the GPU 10b is recommended. The call of these APIs is an example of specific processing.

In the user program 104, the user program 104 itself being executed may call a specific API for the deep learning library 105 through hooking.

The hooking is processing of performing some kind of operation from a call of a specific function or API as a starting point, and may be included as a part of functions executed by the user program 104. The user program 104 may execute, for example, a fit ( ) function or the like by hooking to call the deep learning library 105.

The user program 104 may call the deep learning library 105 via the relay module 103 by loading and executing this relay module 103 by using an import mechanism or the like.

In the scheduling system 1, an API call made for the deep learning library 105 from the user program 104 is input to the relay module 103 by hooking. The relay module 103 to which the API call for the deep learning library 105 is input calls the deep learning library 105 in place of the user program 104. The relay module 103 may input a response from the deep learning library 105 to the user program 104 as desired. The deep learning library 105 may make a response to the user program 104. It may be said that the relay module 103 relays communication between the user program 104 and the deep learning library 105.

In the user program 104, the user program 104 being executed indirectly communicates with the scheduler 101 via the relay module 103 through hooking, and thus, dynamic mapping of computing resources is realized.

The user program 104 communicates with the scheduler 101 by loading and executing the relay module 103 by using an import mechanism or the like. It may be said that the relay module 103 relays communication between the user program 104 and the scheduler 101.

With the mapping of a job, an instruction to activate this mapped job and information on the computing resource (the GPU 10b) that executes the job are transmitted from the scheduler 101 to the user program 104 via the relay module 103.

In a case where a job being executed by the user program 104 is moved to another computing resource, an instruction to stop the user program 104 or an instruction to reactivate the job in the computing resource after the movement may be input from the scheduler 101 to the user program 104 via the relay module 103.

In the scheduling system 1, scheduling in which computing resources (the CPU 10a and the GPU 10b) are mapped to each of a plurality of user programs 104 and a job is executed may be performed.

When job information of a job to be executed is received, the user program 104 performs processing via the deep learning library 105. The user program 104 executes the learning processing until an epoch ends.

When the use of the computing resource ends, the user program 104 notifies the scheduler 101 via the relay module 103 that the computing resource is released (release notification). For example, when processing using the GPU 10b is completed, the user program 104 transmits a GPU release notification to the scheduler 101 via the relay module 103. When processing using the CPU 10a is completed, the user program 104 transmits a CPU release notification to the scheduler 101 via the relay module 103.

The deep learning library 105 is software that functions as a base of the user program 104. The deep learning library 105 may be provided for each user program 104.

The deep learning library 105 is software serving as a basis for efficiently advancing machine learning by the user program 104, and may include, for example, a processing pattern or the like frequently used in the user program 104.

The deep learning library 105 may include, for example, known deep learning libraries such as Keras and Pytorch lightning. These deep learning libraries may function as APIs. The user program 104 uses these high-level APIs such as Keras and Pytorch lightning.

The relay module 103 relays communication performed between the user program 104 and the scheduler 101 and communication performed between the user program 104 and the deep learning library 105.

A call (API call) made for the deep learning library 105 from the user program 104 is input to the relay module 103. The relay module 103 to which the API call for the deep learning library 105 is input performs the API call for the deep learning library 105 in place of the user program 104. The relay module 103 may input a response from the deep learning library 105 to the user program 104. Thus, it may be said that the user program 104 indirectly loads and executes the deep learning library 105 via the relay module 103.

The relay module 103 hooks a specific API such as a fit ( ) function among the API calls transmitted from the user program 104, and performs communication with the scheduler 101. This communication may be, for example, transmission of information indicating a content of the specific API call made by the user program 104 for the deep learning library 105.

The call of the specific API includes, for example, a call of an API made at each of the time of transition from pre-processing to learning and the time of transition from learning to pre-processing of next data (post-process) in deep learning.

When the user program 104 calls the specific API for the deep learning library 105, the relay module 103 inserts communication to the scheduler 101 immediately before or immediately after an actual call of a function of the deep learning library 105. A reply to this communication from the scheduler 101 is passed to the relay module 103, and the relay module 103 gives an instruction about switching of a communication device or the like as desired.

Communication, such as the GPU request or the GPU release notification, performed from the user program 104 to the scheduler 101 is also input to the relay module 103.

Communication such as a GPU mapping result notification performed for the user program 104 from the scheduler 101 is also input to the relay module 103.

The scheduler 101 maps a computing resource (the GPU 10b) to the user program 104. The scheduler 101 manages a mapping state of a job to a computing resource in the scheduling system 1. The scheduler 101 manages a mapping state of the GPU 10b (first computing resource).

The scheduler 101 manages the mapping state of the GPU 10b by using a resource table 111. For example, in a case where a job is mapped to the GPU 10b, information specifying the mapped job is stored in association with information specifying the GPU 10b in the resource table 111. In a case where a job is not mapped to the GPU 10b, information indicating that the GPU 10b is in an available state is stored in association with the information specifying the GPU 10b in the resource table 111.

When a GPU mapping request is transmitted from the user process 106, the scheduler 101 checks whether or not there is a GPU 10b mappable to a job of the user process 106, for example, there is a GPU 10b in an available state. In a case where there is the mappable GPU 10b in the available state, the scheduler 101 maps the GPU 10b to the job, and returns a GPU mapping notification to the user process 106. The user process 106 having received the GPU mapping notification processes the job by using the mapped GPU 10b (performs deep learning).

When a notification requesting the mapping of the GPU 10b is output from the user process 106, it is determined whether or not there is the GPU 10b mappable to this user process 106.

In a case where the GPU mapping request is received from the user process 106, and in a case where the GPU 10b is mapped to another user process 106 and the GPU 10b is not mappable to the job, the scheduler 101 notifies the user process 106 having made the notification of the GPU mapping request, of a mapping failure of the GPU 10b.

The user process 106 having received the GPU mapping failure may process the job by using the CPU 10a (deep learning).

In a case where there is the mappable GPU 10b, the scheduler 101 may map the user process 106 to the GPU 10b, and in a case where there is not the mappable GPU 10b, the scheduler 101 may map the user process 106 to the CPU 10a.

In a case where communication performed by hooking the call of the specific API made at each of the time of transition from pre-processing to learning and the time of transition from learning to pre-processing of next data in the user program 104 is input from the relay module 103, the scheduler 101 also performs the mapping of the GPU 10b.

For example, the scheduler 101 may treat, as the mapping request of the GPU 10b, communication performed by hooking the call of the specific API made at each of the time of transition from pre-processing to learning and the time of transition from learning to pre-processing of next data in the user program 104.

Communication performed by hooking the call of the specific API is an example of notification output performed when the specific processing is performed.

When the notification is output in the user process 106, the scheduler 101 determines whether or not there is the GPU 10b mappable to the user process 106.

The scheduler 101 dynamically changes the mapping of the GPU 10b while performing pull-type and push-type communication with the user program 104.

The pull-type communication is mainly used for communication from the user program 104 to the scheduler 101. The pull-type communication enables fine-grained mapping according to processing contents.

For example, immediately before starting to use the GPU 10b, the user program 104 requests the scheduler 101 to map the GPU 10b by the pull-type communication. In a case where the GPU 10b is not mapped in response to this use request of the GPU 10b, for example, in a case where the mapping of the GPU 10b fails, the user program 104 is executed by the CPU 10a.

Immediately after the use of the GPU 10b ends, the user program 104 notifies the scheduler 101 of the release of the GPU 10b by the pull-type communication. For example, after the use of the mapped GPU 10b (the first computing resource), the user process 106 outputs a notification of the computing resource release (the release of the GPU 10b).

On the other hand, the push-type communication is mainly used for communication from the scheduler 101 to the user program 104.

The scheduler 101, for example, requests the user program 104 which is using the GPU 10b to release the GPU 10b by the push-type communication. The release request of the GPU 10b is an example of a resource mapping change request. For example, the scheduler 101 performs communication for making the resource mapping change request to the user program 104.

The scheduler 101 notifies the user program 104 waiting for the release of the GPU 10b (being executed in the CPU 10a) that the GPU 10b is available by the push-type communication.

Generally, the push-type communication enables a dynamic mapping change such as a change from a process having a low mapping priority to a process having a high mapping priority.

For example, when the GPU 10b is released, the scheduler 101 performs reactivation or the like of the process such that a memory resource of the GPU 10b in use may be reused. Consequently, the memory resource of the GPU 10b is released.

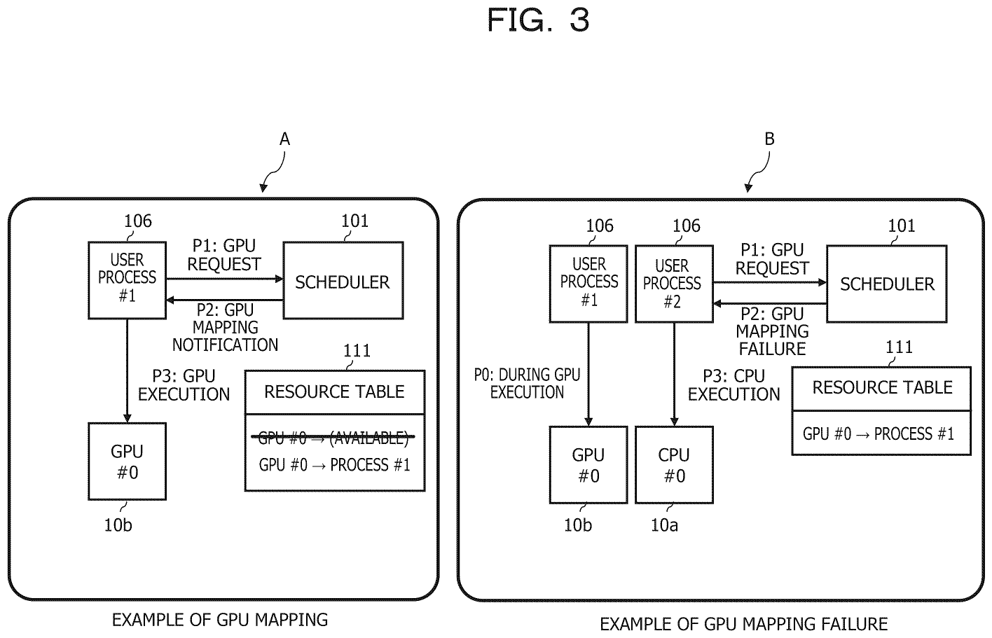

FIG. 3 is a diagram for describing the GPU mapping by the scheduler 101 in the scheduling system 1 according to the embodiment.

Reference sign A in FIG. 3 indicates an example in which the GPU mapping succeeds.

The user process 106 (user process #1) makes a GPU request to the scheduler 101 (see reference sign P1). The scheduler 101 confirms that GPU #0 is in an available state and is mappable with reference to the resource table 111.

The scheduler 101 transmits a GPU mapping notification indicating that the GPU 10b is available (see reference sign P2). The scheduler 101 registers mapping of a GPU #0 to the user process #1 in the resource table 111. A series of communication indicated by these reference signs P1 and P2 corresponds to the pull-type communication.

The user process 106 executes the user program 104 by using the mapped GPU 10b.

Reference sign B in FIG. 3 indicates an example in which the GPU mapping fails.

The user process 106 (user process #1) is executing the user program 104 by using the GPU 10b (GPU #0) (see reference sign P0).

In this state, the user process 106 (user process #2) makes a GPU request to the scheduler 101 (see reference sign P1). The scheduler 101 confirms that GPU #0 is in a mapped state and is not mappable with reference to the resource table 111.

The scheduler 101 notifies the user process #2 of a GPU mapping failure indicating that the GPU 10b is not available (see reference sign P2). A series of communication indicated by these reference signs P1 and P2 corresponds to the pull-type communication. The user process #2 executes the user program 104 by using the CPU 10a (CPU #0) (see reference sign P3).

The scheduler 101 may perform the scheduling of the job based on the priority set for the job.

The priority may be set by, for example, the user process 106 described above. The user process 106 may set the priority to the job by using various methods. For example, the user process 106 may set the priority in accordance with a dummy job execution status of job information of the job.

Before the execution of the user program 104, the user process 106 executes a dummy job to measure the performance of each computing resource. The dummy job may be a part of the job executed by the user program 104, and may be, for example, processing of one epoch of machine learning.

The user process 106 causes each of the CPU 10a and the GPU 10b to execute the dummy job, and acquires each execution time (CPU execution time and GPU execution time). The CPU execution time and the GPU execution time may be acquired from, for example, the deep learning library 105.

The user process 106 calculates an acceleration rate based on the CPU execution time and the GPU execution time. The user process 106 calculates the acceleration rate by dividing the CPU execution time by the GPU execution time. The user process 106 sets the job priority based on the calculated acceleration rate. For example, the user process 106 may set the calculated acceleration rate as a value of the job priority.

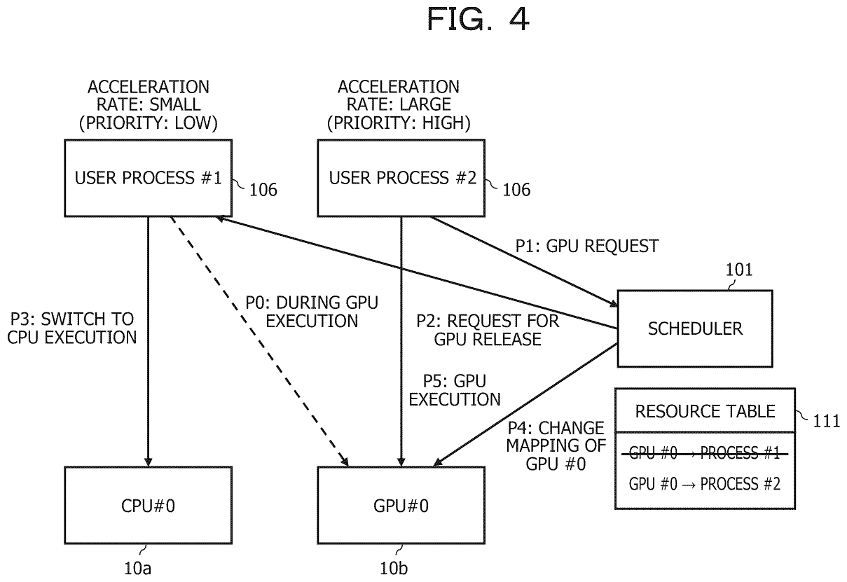

FIG. 4 is a diagram for describing the GPU mapping based on the priority by the scheduler 101 in the scheduling system 1 according to the embodiment.

It is assumed that the user process #2 has a higher acceleration and a higher priority between the user process #1 and the user process #2.

The user process 106 (user process #1) is executing the user program 104 by using the GPU 10b (GPU #0) (see reference sign P0).

In this state, the user process 106 (user process #2) makes a GPU mapping request to the scheduler 101 by the pull-type communication (see reference sign P1).

The scheduler 101 confirms that GPU #0 is in a mapped state and is not mappable with reference to the resource table 111.

The scheduler 101 requests the user process #1 having a low priority to release the GPU 10b by the push-type communication (see reference sign P2).

In response to this GPU release request, the user process #1 switches to the execution of the user program 104 to execution by using the CPU 10a (see reference sign P3). Consequently, the GPU 10b is released. When the GPU 10b is released, the user process #1 performs reactivation or the like of the user process #1 such that another other user process may reuse the GPU memory resources in use. Consequently, the GPU memory is released. The user process #1 notifies the scheduler 101 of the release of the GPU 10b.

The scheduler 101 changes the mapping of the GPU 10b, and maps the CPU 10b to the user process #2 (see reference sign P4). The scheduler 101 transmits the GPU mapping notification indicating that the GPU 10b is available to the user process #2 by the push-type communication. The scheduler 101 registers mapping of GPU #0 to the user process #2 in the resource table 111.

The user process #2 executes the user program 104 by using the mapped GPU 10b (see reference sign P5).

### (B) Operation

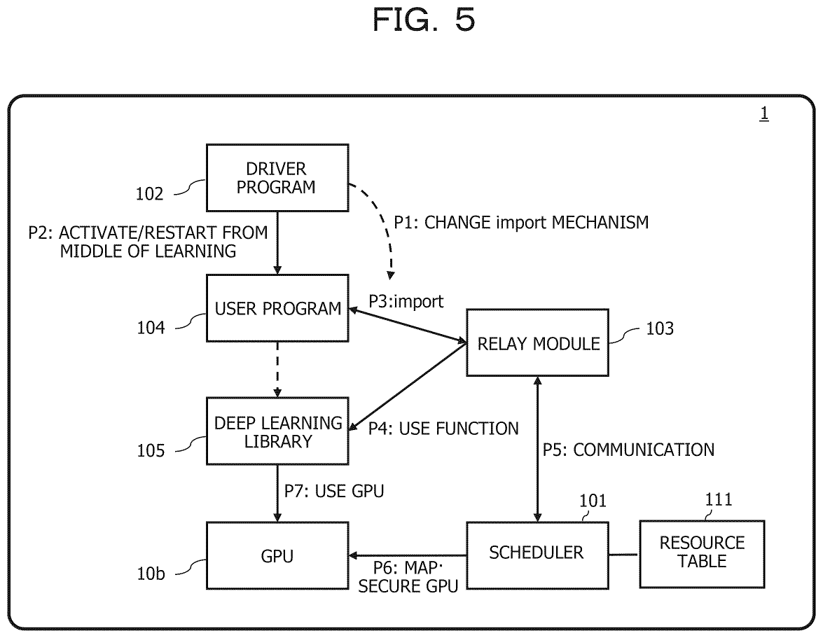

Processing at the time of execution of the user program 104 in the scheduling system 1 according to the embodiment having the above configuration will be described by using FIG. 5.

The driver program 102 changes the import mechanism by changing the semantics (variables and the like) of the module reading in the user program 104 (see reference sign P1). The driver program 102 activates the user program 104 (see reference sign P2). In the user program 104, the module to be read is replaced.

In a case where the computing resource is switched, the user process 106 (user program 104) is temporarily stopped and is restarted over a computing resource after the switching. For example, in a case where the user process 106 receives the mapping notification from the scheduler 101 and detects a change of the computing device, the user process 106 temporarily stops (ends) the execution of the user process 106 itself and returns control to the driver program 102, and the driver program 102 reactivates the user process 106 over another computing device.

The user program 104 performs an import access to read the deep learning library 105. This import access is performed on the relay module 103 (see reference sign P3).

In place of the user program 104, the relay module 103 reads the deep learning library 105 and uses a function thereof (see reference sign P4).

The relay module 103 inserts communication to the scheduler 101 by hooking the specific API (fit ( ) function or the like) in communication from the user program 104 to the scheduler 101 (see reference sign P5).

The scheduler 101 checks the mapping state of the GPU 10b with reference to the resource table 111, and maps the CPU 10b to the user program 104 and secures the CPU 10b in a case where the GPU 10b is mappable (see reference sign P6). The scheduler 101 registers mapping of the GPU #0 to the user process #1 in the resource table 111.

The scheduler 101 transmits the GPU mapping notification via the relay module 103. The user process 106 executes the user program 104 via the deep learning library 105 by using the mapped GPU 10b (see reference sign P7).

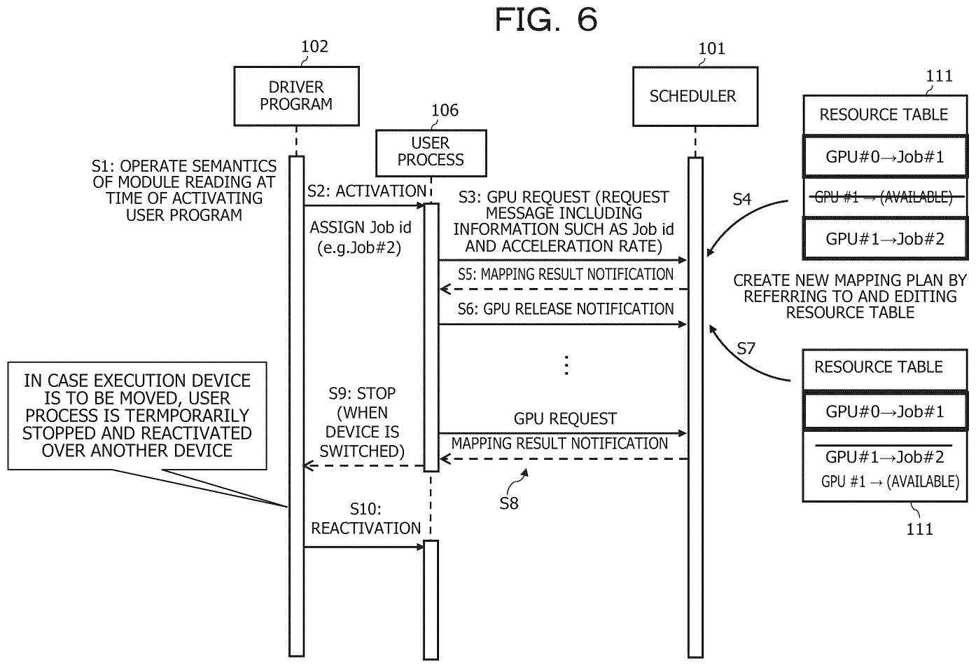

Next, a flow of processing in the driver program 102, the user process 106, and the scheduler 101 of the scheduling system 1 according to the embodiment will be described in accordance with a sequence diagram illustrated in FIG. 6.

The driver program 102 performs replacement of the module to be read by the user program 104 by changing the semantics (variables and the like) of the module reading and executing (activating) the user program 104 (see reference sign S1).

The user process 106 activates a job (see reference sign S2). A job id is assigned to the job with the activation of the job. FIG. 6 illustrates an example in which “Job #2” is assigned as the job id.

The user process 106 transmits a request message for requesting the GPU 10b to the scheduler 101 (see reference sign S3). In addition to the job id of the job executed by the user process 106, information such as an acceleration rate or a priority may be included in this request message.

The scheduler 101 confirms that the GPU #1 is in an unmapped (available) state and is mappable with reference to the resource table 111 (see reference sign S4). The scheduler 101 registers mapping of the GPU #1 to the Job #2 in the resource table 111.

The scheduler 101 transmits a mapping result notification indicating that the GPU #1 is mapped to the Job #2 to the user process 106 (see reference sign S5). In the user process 106, the Job #2 is processed by causing the GPU #1 to execute the user program 104.

When the Job #2 is completed, the user process 106 notifies the scheduler 101 of the release of the GPU #1 (GPU release notification or notification of computing resource release) (see reference sign S6).

When the release notification of the GPU 10b is received, the scheduler 101 performs update for setting the released GPU 10b to an available state in the resource table 111 (see reference sign S7).

Hereinafter, the request for the GPU 10b from the user process 106 to the scheduler 101, the mapping of the GPU 10b by the scheduler 101 in response to this request, the execution of the job and the release of the GPU 10b by the user process 106, and the like are repeatedly executed (reference sign S8).

In a case where the mapping of the computing resource (device) is changed by the scheduler 101 and the device is switched, the user process 106 stops the user process 106 (see reference sign S9), and the user process 106 is reactivated by the driver program 102 in a computing device at a movement destination (see reference sign S10).

### (C) Effects

As described above, according to the scheduling system 1 as the example of the embodiment, the driver program 102 changes the import mechanism by changing the semantics of the module reading in the user program 104, and activates the user program 104. Consequently, the module to be read is replaced in the user program 104, and communication is established between the user program 104 and the scheduler 101 via the relay module 103.

Consequently, communication between the user program 104 and the scheduler 101 is automatically performed at an appropriate timing such as the start of the learning iteration. For example, the user program 104 may notify the scheduler 101 of the GPU mapping request via the relay module 103 immediately before the start of the use of the GPU 10b. Immediately after the use of the GPU 10b ends, the user program 104 may notify the scheduler 101 of the GPU release via the relay module 103.

Thus, the GPU 10b may be appropriately mapped to the job of the user program 104.

As described above, the driver program 102 changes the semantics of the module reading in the user program 104, and thus, the replacement of the module to be read is performed in the user program 104, and the API call made from the user program 104 to the deep learning library 105 is input to the relay module 103 by hooking.

The relay module 103 performs communication (notification) with the scheduler 101 by hooking the specific API such as the fit ( ) function among the API calls transmitted from the user program 104.

In a case where the notification made by hooking the call of the specific API made at each of the time of transition from pre-processing to learning and the time of transition from learning to pre-processing of next data in the user program 104 is input from the relay module 103, the scheduler 101 performs the mapping of the GPU 10b. For example, in the scheduling system 1, a call timing of the specific processing (API) from the user program 104 is used in order to issue communication from the user process 106 to the scheduler 101 at an appropriate timing.

For example, the scheduler 101 performs mapping of the GPU 10b at a timing of transition from learning to pre-processing of next data in the user program 104 to which the GPU 10b is being mapped, the GPU 10b may be mapped to another user program 104. For example, the GPU 10b may be flexibly mapped to the user program 104, and the GPU 10b may be effectively used. In accordance with the processing content of the user program 104, switching of the computing resource may be realized with a fine granularity.

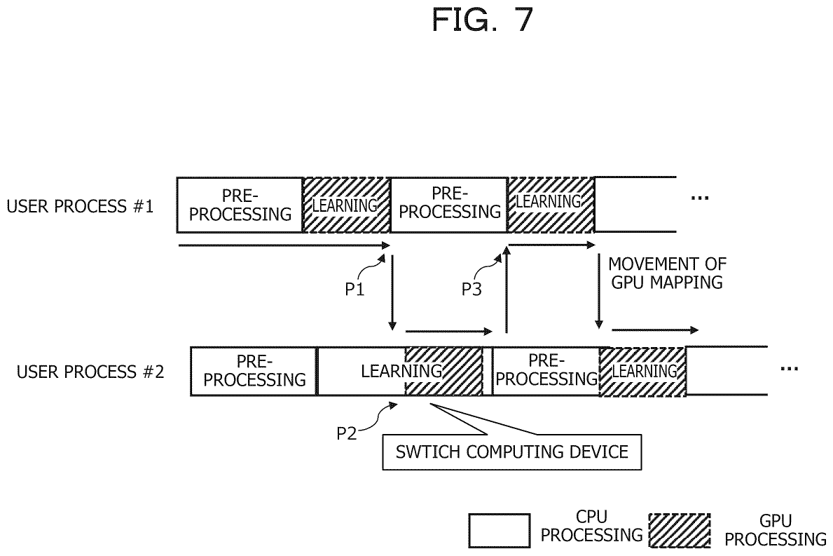

FIG. 7 is a diagram for describing the dynamic mapping of the computing resource in the scheduling system 1 according to the embodiment.

FIG. 7 illustrates an example in which the scheduler 101 dynamically maps the GPU 10b to the user process #1 and the user process #2.

In the scheduling system 1, the scheduler 101 performs mapping of the GPU 10b at each timing of the time of transition from pre-processing to learning and the time of transition from learning to pre-processing of next data in the user program 104. For example, the scheduler 101 maps the GPU 10b to the user process 106 which is executing learning.

In FIG. 7, periods (GPU processing) in which the GPU 10b is mapped and the job is processed in the user processes #1 and #2 are depicted by hatching.

The user process 106 to which the GPU 10b is not mapped executes the job by using the CPU 10a. In FIG. 7, periods (CPU processing) in which the job is processed by using the CPU 10a are depicted by white filling.

While the GPU 10b is mapped to the user process #1 in the example illustrated in FIG. 7, the computing device (the GPU 10b) is switched at a timing when the user process #1 transitions from learning to pre-processing of next data (see reference sign P1), and the GPU 10b is mapped to the user process #2 in the middle of learning (see reference sign P2). In the user process #1, pre-processing is performed by using the CPU 10a.

Thereafter, the GPU 10b is mapped to the user process #1 at a timing when the user process #2 transitions from learning to pre-processing of next data and the user process #1 transitions from pre-processing to learning (see reference sign P3).

Consequently, in the user process #1, learning is performed by using the GPU 10b having a high processing performance, and pre-processing for which the GPU 10b is not desired is performed by using the CPU 10a. While the user process #1 is executing the pre-processing, the user process #2 may perform learning by using the GPU 10b. For example, the GPU 10b is not occupied while the user process 106 is executing processing for which the GPU 10b is not desired, and the user program 104 is not executed regardless of whether or not the GPU 10b is mapped.

In the case using the method of the related art, in a case where the GPU 10b is mapped to the user process #1, the user process #2 is unable to use the GPU 10b and uses only the CPU 10a in all steps of the processing. Consequently, a processing time of the user process #2 increases.

In contrast, in the scheduling system 1, in the first user process 106 (user process #1) among the plurality of user processes 106, the learning is performed by using the GPU 10b having a high processing performance, and the pre-processing for which the GPU 10b is not desired is performed by using the CPU 10a. Consequently, the processing time of the user process #2 may be reduced by mapping the GPU 10b to the other user process 106 (user process #2) and using the GPU 10b. For example, the GPU 10b may be efficiently mapped to the plurality of user processes 106, and the use efficiency of the GPU 10b may be improved.

By using hooking, access from the user program 104 to the scheduler 101 and access from the user program 104 to the deep learning library 105 are performed via the relay module 103. Consequently, the scheduler 101 or the like may access an internal state of the user program 104 including an execution timing of the processing in the user program 104 and contents of a temporary memory (not illustrated). The following effects may be obtained by utilizing this.

For example, the timing of the resource mapping may be synchronized with the execution of the user program 104. For example, it is possible to reduce a time from when the computing resource is desired to when the computing resource is mapped and a time from when the computing resource is no longer desired to when the computing resource is released, and thus, it is possible to improve real-time performance.

Information regarding the internal state of the user program 104 (for example, details of a neural network model being executed) may be included in the content of the communication with the scheduler 101. These pieces of information may be utilized for optimum resource mapping to the user program 104.

In processing within the hooking, the content of the temporary memory in the GPU 10b may be read and saved in the storage unit 10d or the like, and may be restored later or the like. This processing means that, when the computing resource is released, the computing resource including the memory resource specific to the computing resource may be completely released.

At a stage at which the user process 106 (user program 104) finishes the use of the computing resource (GPU 10b or CPU 10a), the user process 106 notifies the scheduler 101 of the release of the computing resource via the relay module 103. Consequently, the scheduler 101 recognizes that the process using the computing resource (GPU 10b) has already finished the use of the computing resource and has released the computing resource. Consequently, after a certain user process 106 uses a computing resource, the computing resource may be used by another user process 106 without waiting for the certain user process 106 to be completely ended.

### (D) Others

Each configuration and each processing of the present embodiment may be selectively employed or omitted as desired, or may be combined as appropriate.

The disclosed technique is not limited to the above-described embodiment. The present embodiment may be carried out while being modified in various ways without departing from the gist of the present embodiment.

For example, in the above-described embodiment, while the computer 10 constituting the scheduling system 1 is used as a single computing node and the processing is executed over the computer 10, the configuration is not limited thereto. A cluster configuration including a plurality of computing nodes (computers 10) may be constructed, and the scheduling system 1 may be constructed by using the cluster configuration.

While the configuration example in which the two CPUs 10a-1 and 10a-2 and the two GPUs 10b-1 and 10b-2 are included in the computer 10 is illustrated in the above-described embodiment, the configuration is not limited this configuration example. One or three or more of at least one of the CPU 10a and the GPU 10b may be provided.

The above-described disclosure enables a person skilled in the art to carry out and manufacture the present embodiment.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. A non-transitory computer-readable recording medium storing a scheduling program for causing a computer that includes a first computing resource and a second computing resource that has a processing performance lower than a processing performance of the first computing resource to execute a process comprising:
activating a process; and
managing a mapping state of the first computing resource, wherein
in the activating, execution of the process is registered as a target of the management of the mapping state of the first computing resource,
it is determined whether or not there is the first computing resource mappable to the process when a notification that requests mapping of the first computing resource is output from the process,
the process is mapped to the first computing resource in a case where there is the mappable first computing resource, and
the process is mapped to the second computing resource in a case where there is not the mappable first computing resource.

2. The non-transitory computer-readable recording medium according to claim 1, wherein
the managing of the mapping state includes
performing communication for requesting the process to change mapping of a computing resource.

3. The non-transitory computer-readable recording medium according to claim 1, wherein the process outputs a notification of computing resource release after the use of the mapped first computing resource or second computing resource.

4. A non-transitory computer-readable recording medium storing a scheduling program for causing a computer that includes a first computing resource and a second computing resource that has a processing performance lower than a processing performance of the first computing resource to execute a process comprising:
activating a process; and
managing a mapping state of the first computing resource, wherein
in the activating, notification output is performed when specific processing is performed in the process,
in the managing of the mapping state, it is determined whether or not there is the first computing resource mappable to the process when the notification output is performed in the process,
the process is mapped to the first computing resource in a case where there is the mappable first computing resource, and
the process is mapped to the second computing resource in a case where there is not the mappable first computing resource.

5. The non-transitory computer-readable recording medium according to claim 4, wherein
the managing of the mapping state includes
performing communication for requesting the process to change mapping of a computing resource.

6. The non-transitory computer-readable recording medium according to claim 4, wherein the process outputs a notification of computing resource release after the use of the mapped first computing resource or second computing resource.

7. An information processing apparatus comprising:
a first computing resource;
a second computing resource that has a processing performance lower than a processing performance of the first computing resource; and
a processor configured to:
activate a process;
manage a mapping state of the first computing resource;
in an activation, register execution of the process as a target of the management of the mapping state of the first computing resource;
determine whether or not there is the first computing resource mappable to the process when a notification that requests mapping of the first computing resource is output from the process;
map the process to the first computing resource in a case where there is the mappable first computing resource; and
map the process to the second computing resource in a case where there is not the mappable first computing resource.

8. The information processing apparatus according to claim 7, wherein
the processor performs communication to request the process to change mapping of a computing resource.

9. The information processing apparatus according to claim 7, wherein the process outputs a notification of computing resource release after the use of the mapped first computing resource or second computing resource.
